(19) United States
(12) Patent Application Publication
(10) Pub. No.: US 2018/0335155 A1
(43) Pub. Date: Nov. 22, 2018

(54) CHECK VALVE STRUCTURE OF BAG BODY AND PRODUCTION METHOD FOR THE SAME

(71) Applicant: TANAKA TECHNICAL CORPORATION, Tenri-shi, Nara (JP)

(72) Inventor: Mikio TANAKA, Tenri-shi (JP)

(73) Assignee: TANAKA TECHNICAL CORPORATION, Tenri-shi, Nara (JP)

(21) Appl. No.: 15/528,033

(22) PCT Filed: Oct. 29, 2015
(86) PCT No.: PCT/JP2015/080529

§ 371 Date: May 18, 2017

(30) Foreign Application Priority Data
Nov. 21, 2014 (JP) 2014-236206

(51) Int. Cl. F16K 15/16; B31B 50/84

(52) U.S. Cl. CPC F16K 15/16; B31B 50/84

(57) ABSTRACT

A check valve structure with which a fluid can satisfactorily open the valve and pass therethrough during a forward flow is provided. By disposing the entire check valve inside of a sealing bag, a check valve structure of a bag body capable of responding to deformation of a valve sheet of the check valve when pressure is applied in a thickness direction of the sheet, and a production method for the same are provided. The check valve structure is comprised of a bag sheet that forms a bag body, and a check valve made of a sheet and fixed to the bag sheet. The check valve includes a valve sheet, a fluid path forming sheet, and a basic sheet, and includes a filter sheet if necessary. The valve sheet is fixed by a valve sheet fixing portion at an upper end side, and moves in its thickness direction at a lower end side to open or close the valve. An inlet is provided at an upper side than the valve sheet fixing portion, and an outlet is provided at a lower side. The sheet that forms the check valve and the bag sheet have a deformed portion where the sheet itself protrudes rearward formed further upstream than the valve sheet fixing portion, particularly, in a part including the inlet.

### FIELD OF THE ART

The present invention relates to a check valve structure of a bag body and a production method for the same. Conventionally, there have been sealing bags with which an article containing portion that includes a space for containing clothing, food, or other articles can be sealed in a gastight state. With such a sealing bag, a check valve connecting the article containing portion and the outside of a bag in a ventable manner is used to evacuate air and various other gases present in the article containing portion to the outside of the bag and maintain the evacuated state. Also, for a bag that contains grains such as coffee beans, a check valve has been used to evacuate a gas generated from the contained grains to the outside of the bag.

In the evacuation of gas, the check valve can allow passage of gas flow in one direction while blocking gas flow in another direction by opening and closing of a gas flow passage space that is a space through which the gas passes.

The inventor of the present invention has made many inventions that relate to check valves, and one of the conventional examples is a check valve described in Patent Document 1. This check valve is comprised of flexible outer base sheets made of resin and a plurality of valve sheets, and at least two sheets of the valve sheets forming a single set comprises an upstream valve sheet and a downstream valve sheet, and are both adhered to one outer base sheet. The adhesion of the upstream valve sheet to the one outer base sheet is achieved at an upstream side with a downstream side being provided as a movable portion with respect to the outer base sheets. On the other hand, the adhesion of the downstream valve body sheet is achieved at a downstream side with an upstream side being provided as a movable portion with respect to the outer base sheets. The movable portions (i.e., the downstream side of the upstream valve sheet and the upstream side of the downstream valve sheet) are capable of contacting closely and separating with respect to another outer base sheet. Each of the valve body sheets that forms the single set is adhered to one outer base sheet, and the one outer base sheet is made of a nonwoven fabric having gas permeability across its entire surface. Moreover, the check valve is used with the part including a nonwoven fabric located inside of a sealing bag as an inlet during forward flow into the check valve, and with an outlet from the check valve located outside the sealing bag.

Also for the check valves described in Patent Document 2 and Patent Document 3, a nonwoven fabric having gas permeability is used, and each of the check valves is fixed to a sealing bag with the part including a nonwoven fabric located inside of the sealing bag as an inlet during forward flow, and with its outlet located outside of the sealing bag.

The check valves disclosed in these patent documents are, as above, both fixed as check valves across the inside and outside of sealing bags. Particularly, the check valves described above are fixed to sealing bags so that the movable portions of the valve sheets are substantially positioned outside the sealing bags.

The inventor of the present invention made attempts to improve these check valves, and attempted to develop a check valve the whole of which can be located inside a sealing bag. However, when the whole of the check valve was located inside a sealing bag, a problem occurred that the check valve does not operate satisfactorily during a forward flow. In detail, during a forward flow, the inside of a sealing bag is increased in pressure, and fluid flows out, through the check valve, from the inside to the outside of the sealing bag, and on the other hand, in the case of implementation as a check valve that checks an inflow of fluid from the outside to the inside of a sealing bag, when the inside of the sealing bag increases in pressure, the respective sheets that form the check valve such as valve sheets receive pressure in their thickness direction, and the entire check valve is pressed against a bag sheet of the sealing bag, and the check valve therefore cannot be opened, and the fluid may not satisfactorily flow out through the check valve.

In view of the circumstances described above, prior to the present invention, the check valve described in Patent Document 4 was developed for the purpose of providing a check valve with which a fluid can satisfactorily open the valve and pass therethrough during a forward flow. The check valve has a fluid introduction recess portion which is formed in at least either one of a valve sheet and a sheet to be overlapped therewith that form a valve flow path and is recessed in its thickness direction. The fluid introduction recess portion is provided, in an up/down direction of the flow path, at a fixing portion of an upstream end of the valve sheet or a position that is further upstream than the fixing portion. With this, even when the respective sheets that form the check valve such as valve sheets receive pressure in their thickness direction, fluid is introduced from the fluid introduction recess portion, and the fluid thus can flow out through the check valve satisfactorily.

However, the proposal of Patent Document 4 was made, on the assumption that the respective sheets are deformed when the entire check valve is pressured against the bag sheet of the sealing bag, so that fluid is introduced from the fluid introduction recess portion even when the deformation occurs, and is not an improvement focused on deformation itself of the respective sheets. Moreover, as the fluid introduction recess portion is formed on one surface of the sheet by a press mold, it is difficult to make the recess greater in degree than a sheet thickness.

### PRIOR ART DOCUMENT

### Patent Document

Patent Document 1: Japanese Patent No. 4436925
Patent Document 2: Japanese Patent No. 2691881
Patent Document 3: Japanese Patent No. 3012968
Patent Document 4: Japanese Patent No. 4761408

### SUMMARY OF THE INVENTION

### Object of the Invention

An object of the present invention is to provide a check valve structure with which a fluid can satisfactorily open the valve and pass therethrough during a forward flow. An object of the present invention is, particularly, by disposing the entire check valve inside of a sealing bag, to provide a check valve structure of a bag body capable of responding to deformation of a valve sheet of the check valve when pressure is applied in a thickness direction of the sheet, and a production method for the same.

### Means for Achieving the Object

The present invention relates to a check valve structure of a bag body including a bag sheet that forms a bag body, and a check valve made of a sheet and fixed to the bag sheet.

The check valve made of a sheet is comprised of at least a valve sheet, a fluid path forming sheet disposed in front of the valve sheet, and a basic sheet disposed behind the valve sheet.

The valve sheet is fixed by a valve sheet fixing portion at an upper end side, is movable in a thickness direction at a lower end side, has an inlet provided at an upper side than the valve sheet fixing portion, and has an outlet provided at a lower side than the valve sheet fixing portion.

The flow path forming sheet includes an upstream portion that is at an upper side than the valve sheet fixing portion, and a downstream portion that is at a lower side than the valve sheet fixing portion. The valve sheet, by its movement in the thickness direction, contacts and separates from the downstream portion of the flow path forming sheet to open or close the valve, and the check valve controls flow of a fluid inside and outside of the bag body that is performed through opening portions.

In a region including the upstream portion that is at an upper side than the valve sheet fixing portion, a deformed portion is formed on at least one sheet of the sheets that form the check valve. The sheet itself of the deformed portion protrudes rearward relative to a part without deformation, and a front surface of the deformed portion is recessed rearward relative to a front surface of a part without deformation, and a rear surface of the deformed portion protrudes rearward relative to a rear surface of a part without deformation.

In the check valve structure of the present invention, even when the check valve is applied with pressure in its thickness direction, by the deformed portion that protrudes rearward, the sheets themselves that form the check valve are suppressed from being deformed in a forwardly protruding manner. Also, even if deformation occurs, because the sheets themselves are deformed irregularly in most cases, a gap occurs readily between the sheets, and a flow of fluid during forward flow occurs from the gap, which can open the valve.

The present invention may be executed as an embodiment wherein a filter sheet is disposed at a position to cover at least the inlet from behind, and in a region including the inlet, the deformed portion is formed on all sheets that form the check valve and the bag sheet.

The deformed portion can be, in at least a portion thereof, recessed rearward relative to a front surface of an attaching seal.

Moreover, the present invention may also be executed as an embodiment wherein a filter sheet is disposed at a position to cover at least the inlet from behind, and in a region including the inlet, at least the filter sheet of the sheets that form the check valve has the deformed portion formed thereon.

Moreover, the deformed portion can be formed, by a deformation maintaining member disposed further to the front than the filter sheet to the rear, due to at least the filter sheet being recessed.

Moreover, the present invention may be executed as an embodiment wherein the bag sheet is formed with an opening portion, the check valve is fixed by an attaching seal at a position to cover the opening portion from behind, the attaching seal seals the bag sheet and the check valve in an entire periphery of the check valve, and the inlet is open to the rear in a region at an upper side than the valve sheet fixing portion of the check valve.

The inlet is open to the front in a region at a lower side than the valve sheet fixing portion of the check valve, and when a pressure inside the bag has become higher than a pressure outside the bag, a fluid inside the bag flows in the inside of the check valve from the inlet, passes between the flow path forming sheet and the valve sheet, and flows out to the outside of the bag from the opening portion via the outlet.

The opening portion may be disposed at an appropriate position of a front side of the check valve. At this time, providing the opening portion that includes an upper opening portion positioned in front of the deformed portion is advantageous in that, in its production, the deformed portion is formed readily by a protrusion portion provided on a substrate. In addition, the number of opening portions may be one, and may be two or more. Accordingly, implementation with only the upper opening portion or implementation with only a lower opening portion positioned in front of the outlet may be possible, and both opening portions may be provided. Also, the opening portion may be continuous in an up/down direction.

Moreover, the present invention provides a method for producing a bag body provided with a check valve structure. Specifically, when fixing a check valve made of a sheet to a bag sheet that forms a bag body, the bag sheet having an opening portion formed therein and the check valve are prepared. The production method includes a fixing step of then disposing the check valve at a position behind the opening portion, and fixing an entire periphery of the check valve to the bag body by an attaching seal.

As the check valve, one can be used that is comprised of a valve sheet being fixed by a valve sheet fixing portion at an upper end side, being movable in a thickness direction at a lower end side, an inlet and an outlet provided across the valve sheet fixing portion at an inner side and a lower side, respectively, a flow path forming sheet disposed in front of the valve sheet, and a basic sheet disposed behind the valve sheet. The flow path forming sheet includes an upstream portion that is at an upper side than the valve sheet fixing portion, and a downstream portion that is at a lower side than the valve sheet fixing portion. The valve sheet, by its movement in the thickness direction, contacts and separates from the downstream portion of the flow path forming sheet to open or close the valve, and the check valve controls flow of a fluid inside and outside of the bag body that is performed through the opening portion.

As the fixing step, a protrusion portion is formed on a substrate, the check valve is disposed on the substrate in alignment so that at least a portion that is at an upper side than the valve sheet fixing portion is positioned in front of the protrusion portion and an outer periphery of the check valve is positioned in front of the substrate without the protrusion portion, and the bag sheet is disposed on the check valve. Then, an outer periphery of the check valve and the bag seat are sealed from above the bag sheet. A deformed portion that protrudes rearward relative to the attaching seal is thereby formed in at least a region including the upstream portion of the flow path forming sheet.

### Effect of the Invention

The present invention can provide a check valve structure with which a fluid can satisfactorily open the valve and pass therethrough during a forward flow, and a production method for a bag body provided with the same check valve structure.

### BRIEF DESCRIPTION OF THE DRAWINGS

FIG. 1A is a front view of a check valve to be used for a check valve structure of a bag body according to a first embodiment of the present invention, which is a check valve before being fixed to the bag body, and FIG. 1B is a central longitudinal sectional view of the same.

FIG. 2A is a front view of principal portions of a bag body provided with the check valve structure of a bag body according to the same embodiment, FIG. 2B is a central longitudinal sectional view of the same bag body, FIG. 2C is a transverse sectional explanatory view of the principal portions of FIG. 2A, and FIG. 2D is a sectional explanatory view in a state where the pressure in the bag body of FIG. 2C is increased.

FIG. 3 shows production steps of the bag body according to the same embodiment with FIG. 3A being an explanatory view of the first step, FIG. 3B being an explanatory view of the second step, and FIG. 3C being an explanatory view of the third step.

FIG. 4A is a front view of principal portions of a bag body provided with a check valve structure of a bag body according to a second embodiment of the present invention, FIG. 4B is a central longitudinal sectional view of principal portions of the same bag body, and FIG. 4C is a central longitudinal sectional view of principal portions of a bag body showing a modification of FIG. 4B.

FIG. 5A is a front view of principal portions of a bag body provided with a check valve structure of a bag body according to a third embodiment of the present invention, and FIG. 5B shows a production step of the bag body according to the third embodiment, and is an explanatory view of a step corresponding to the third step according to the first embodiment.

### MODES FOR CARRYING OUT THE INVENTION

Embodiments of the present invention shall now be described based on the drawings. In the sectional views of the respective figures, the front or a front surface direction is shown by an arrow f, and the rear or a rear surface direction is shown by an arrow b. Also, in the sectional views of the respective figures, the sheets are drawn with intervals therebetween and their respective thicknesses greater than the actual ones in order to show the structure simply, and the respective sheets are overlapped in actuality. Expressions indicating positions and directions, such as “front and rear,” “front and back,” “upper, lower, right, and left,” “longitudinal and lateral,” “one and other,” etc., written in the claims and specification of the present invention are limited to indicate relative positional relationships and do not specify absolute positions, and the present invention should not be understood to be limited to these modes. The expressions of “upstream and downstream” are based on a positive direction (direction to allow passage of a fluid when a check valve is used, in other words, a flow direction when the valve opens).

(Outline of Overall Arrangement)

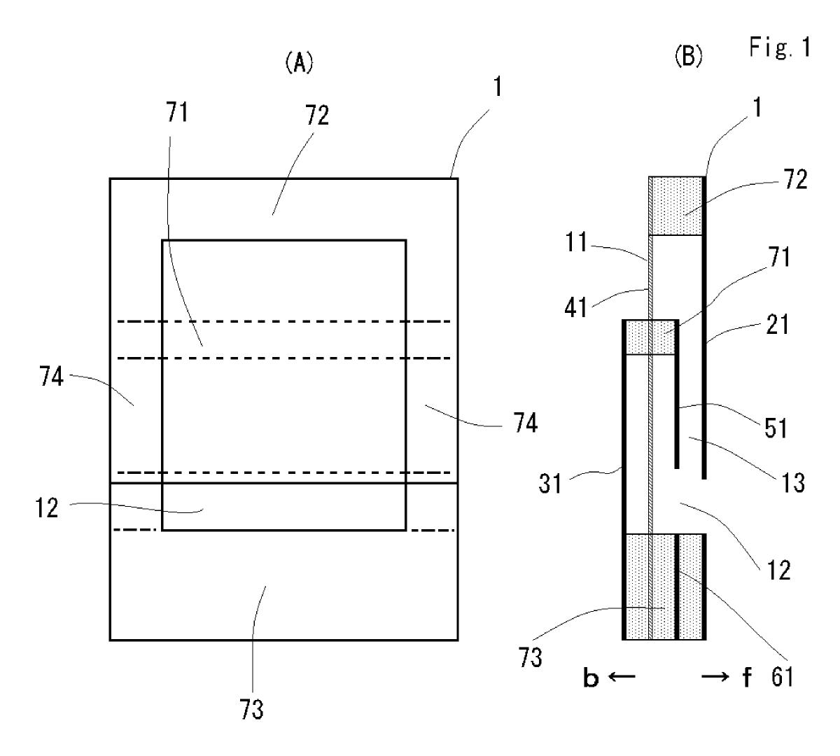

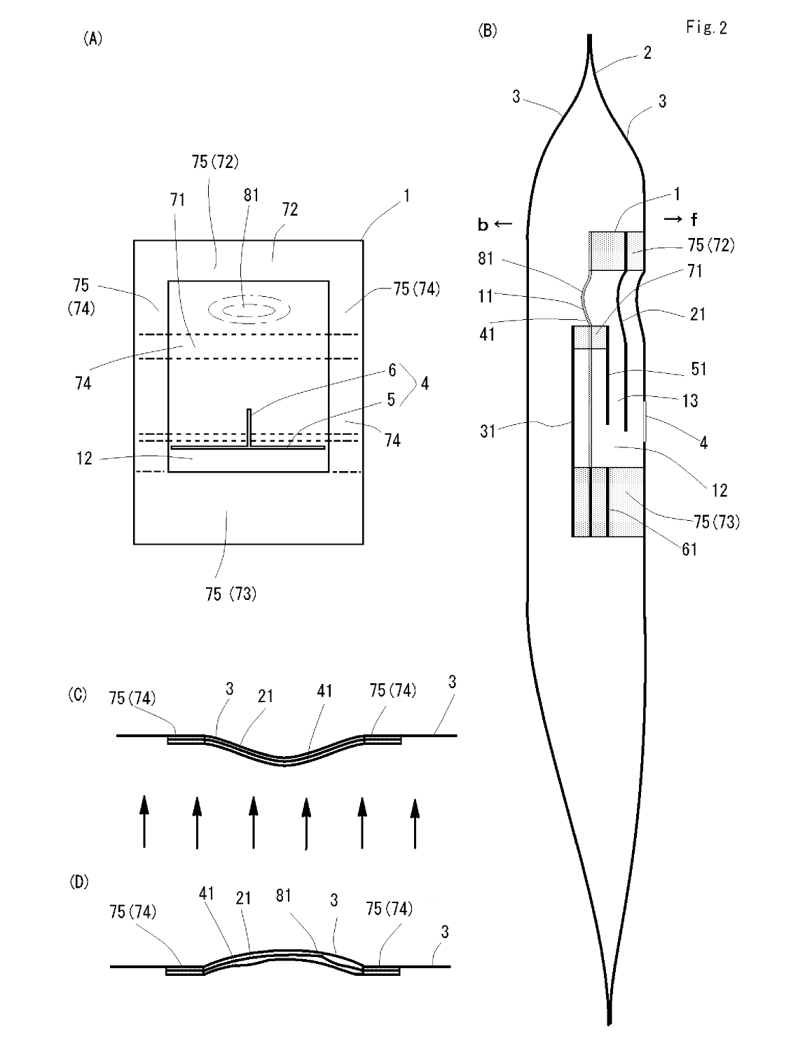

A check valve structure of a bag body according to the present embodiment is a structure for which a check valve 1 shown in FIG. 1 is fixed to a bag sheet 3 of a bag body 2 shown in FIG. 2. When fixing the check valve 1 to the bag sheet 3, a deformed portion 81 is formed in the check valve 1, and FIG. 1 illustrates a check valve 1 in a state before a deformed portion 81 is formed therein, and FIG. 2 illustrates a bag body 1 provided with a check valve 1 after a deformed portion 81 was formed therein.

The bag body 2 includes in a part or the whole thereof a bag sheet 3 having flexibility and gastightness, and is formed into a bag shape by welding, adhesion of an adhesive, or the like. Inside of the bag body 2, a containing article such as coffee beans is contained. Because gas is emitted from roasted coffee beans, a check valve is sometimes used, when coffee beans are contained in a sealing bag, as a means for evacuating the generated gas to the outside of the sealing bag. The present embodiment proposes an optimal structure of the check valve 1 made of sheets for a coffee bag. The check valve 1 is fixed to an inner side of the bag body 2, in more detail, an inner surface side of the bag sheet 3 in alignment with an opening portion 4 provided in the bag sheet 3. Specifically, a front surface side (right-hand surface with an arrow f in FIG. 2B) of the check valve 1 is fixed to aback surface of the bag sheet 3 (a surface to be an inner side of the bag body 2), with an attaching seal 75, through fusion, adhesion by an adhesive, or the like.

As shown in FIG. 2, the check valve 1 is fixed, by the attaching seal 75, by sealing an entire periphery of the check valve 1 to the bag sheet 3 at upper, lower, right, and left sides. A fluid inside the bag body 2 flows in from an inlet 11 at a rear surface side of an upper portion in FIG. 2B, passes through a valve flow path 13 in the check valve 1, and flows out from the opening portion 4 to the outside of the bag body 2 via an outlet 12 at a front side of a lower portion. In a state of being fixed to the bag body 2, the check valve 1 is described on the assumption that the upstream inlet 11 is at an upper position and the downstream outlet 12 is at a lower position. Accordingly, in all descriptions that follow, unless otherwise specified, words indicating “upper” positions such as “upper,” “upward/above,” and “upper portion” can be read as “upstream,” and words indicating “lower” positions such as “lower,” “downward/under,” and “lower portion” can be read as “downstream.”

(Overview of Respective Sheets)

Here, an overview of respective sheets will be described with reference to FIG. 1 and FIG. 2. The check valve 1 includes a flow path forming sheet 21, a base sheet 31, a filter sheet 41, and a valve sheet 51. Further in this example, an auxiliary sheet 61 is disposed under the valve sheet 51, but implementation without using the auxiliary sheet 61 is also possible. These four sheets (five sheets including the auxiliary sheets 61) have lateral widths (right-left widths in FIG. 1A) set equal to each other. For convenience of description, the respective sheets are drawn with their thicknesses and intervals greater than the actual ones in the respective sectional views, but in actuality, the respective sheets are overlapped in contact, and made of single or laminate thin films such as synthetic resin films or nonwoven fabrics.

Of the above sheets, two sheets of the flow path forming sheet 21 and the basic sheet 31 are made of single or composite gastight synthetic resin films (which do not allow an intended fluid such as a gas to pass therethrough).

The filter sheet 41 is made of a sheet with gas permeability (which allows an intended fluid to pass in a thickness direction) such as a nonwoven fabric or a woven fabric. This filter sheet 41 is for preventing fragments and fine powder of coffee beans being a containing article from entering into the check valve 1, and in the case of a containing article from which no fine powder is produced, the filter sheet 41 can be omitted.

The valve sheet 51 is fixed movably so as to open or close the valve, and made of a single or composite synthetic resin film. As the valve sheet 51, in terms of the point of moving in its thickness direction to open or close the valve, it is preferable to use one that is thinner than the fluid path forming sheet 21 and the basic sheet 31 and highly flexible, but the valve sheet 51 should not be understood to be limited thereto.

In addition to the four sheets, an auxiliary sheet 61 can also be disposed at a lower end of the check valve 1. This auxiliary sheet 61 is provided for maintaining the shape and thickness of the valve sheet 51 in balance, and it is preferable to use one that is the same in material and thickness as the valve sheet 51, but the auxiliary sheet 61 should not be understood to be limited thereto. The valve sheet 51 and the auxiliary sheet 61 may be, in their production process, formed by one identical sheet and then formed by cutting or cutting-off therebetween.

As these sheets, sheets of laminated synthetic resin films can be used, but by disposing self-close-contacting films at a rear surface side of the flow path forming sheet 21 and a front surface side of the valve sheet 51, close contact of the two components can be increased, which can enhance a reverse flow prevention function of preventing a reverse flow of fluid in the valve flow path 13.

The bag sheet 3 can be variously changed according to the type of a containing article, etc., and various sheets can be used such as single or laminate synthetic resin films and ones made of composite materials with another material such as a metal film or paper.

(Positional Relationships and Adhering States of Respective Sheets)

While positional relationships and adhering states of these sheets shall now be described, description will be given with a back surface side being shown as a rear side and a front surface side being shown as a front side in FIG. 1 and FIG. 2.

First, the basic sheet 31 is disposed at a rearmost side, that is, a back surface side (left side in FIG. 1B and FIG. 2B), and the filter sheet 41 is disposed in front thereof.

The valve sheet 51 and, if necessary, the auxiliary sheet 61 are disposed at a front surface side of the filter sheet 41, and further at a front surface side thereof, the flow path forming sheet 21 is disposed, and these sheets form the check valve 1. With the bag sheet 3 disposed at a front surface side of the check valve 1, the check valve 1 is fixed by being sealed in the entire periphery thereof to the bag sheet 3 by the attaching seal 75.

Both right and left ends of these sheets are, in the same manner as with other check valves of this type, joined to each other by side seals 74.

This joining is preferably welding such as heat sealing or ultrasonic sealing, but may be performed by an adhesive (hereinafter, the same applies to not only this seal but also other seals). This side seal 74 can also serve in common as the attaching seal 75. In detail, by applying the attaching seal 75 at the time of fixing to the bag sheet 3 without the side seal 74 being applied before fixing to the bag body 2, the applied seal can serve as the attaching seal 75 as well as the side seal 74. Also, even when the side seal 74 and the attaching seal 75 are provided separately, providing the side seal 74 to be narrower than the attaching seal 75 and laying the attaching seal 75 on a position covering the side seal 74 to provide sealing is also possible. Also, two narrow seals may be applied as the side seal 74, and the attaching seal 75 may be applied to a non-seal part, which is a part with no seal provided between the two narrow side seals. FIG. 1 shows the side seal 74 formed in the check valve 1, and the illustration is made in a mode where the attaching seal 75 is formed at the same position as the side seal 74 in an overlapping manner.

The relationship between the basic sheet 31 and the filter sheet 41 will be described. The filter sheet 41 is located across substantially an entire length of the check valve 1, and the basic sheet 31 is located on a rear surface side of the filter sheet 41. As shown in FIG. 2B, the basic sheet 31 has a vertical length set shorter than that of the filter sheet 41, the basic sheet 31 is not overlapped with an upper portion of the filter sheet 41, and the filter sheet 41 is thus exposed. The filter sheet 41 has gas permeability as described above, and the exposed part corresponds to a fluid passage portion that serves as the inlet 11 to the inside of the check valve 1.

The basic sheet 31 is overlapped with a lower portion of the filter sheet 41, and an upper end of the basic sheet 31 is fixed to the filter sheet 41 by a valve sheet fixing portion 71. Similar to the side seal 74 described above, this valve sheet fixing portion 71 is also preferably achieved by welding such as heat sealing or ultrasonic sealing, but may be formed by an adhesive. The valve sheet fixing portion 71 is formed so as to connect both right and left sides of the check valve 1 (between the left side seal 74 and the left side seal 74), and serves as a boundary between the inlet 11 and the opening and closing valve flow path 13. The valve sheet fixing portion 71 is formed of a single seal in this example, but may be formed by, for example, providing a plurality of seals in parallel. By further having the entire surface of the basic sheet 31 in a portion lower (further downstream) than the valve sheet fixing portion 71 sealed by heat welding or the like, the check valve 1 may be made pliable and hard to break. This allows suppressing the occurrence of such a phenomenon that the check valve 1 warps toward a front side (outer side of the bag body 2) due to variation in fluid pressure inside the bag body 2.

A lower portion of the basic sheet 31 is joined by a lower seal 73 to a lower portion of the filter sheet 41 (when an auxiliary sheet 61 is used, also to the auxiliary sheet 61). The lower seal 73 is provided for sealing across both right and left sides (between the right and left side seals 74) of the check valve 1. This lower seal 73 can also even serve in common as the attaching seal 75, and can adopt various embodiments described with the side seal 74 in the foregoing.

The basic sheet 31 is implemented as one that covers a portion of the filter sheet 41 except the inlet 11, and in the covered part, the filter sheet 41 does not exert its function. Therefore, although illustration is omitted, the lower portion of the filter sheet 41 covered with the basic sheet 31 can be implemented without providing the filter sheet 41 in part or in whole. In other words, a portion higher than the valve sheet fixing portion 71 may be provided only with the filter sheet 41, and a portion lower than the valve sheet fixing portion 71 may be provided only with the basic sheet 31. However, the portion higher than the valve sheet fixing portion 71 may also be provided with the basic sheet 31, and may be formed in a part thereof with an opening that serves as the inlet 11. Also, by providing the basic sheet 31 also in the portion higher than the valve sheet fixing portion 71 across its entire surface and not sealing the gap with the flow path forming sheet 21 in part, the non-sealed part may even be used as the inlet 11, but in this case, it is necessary not to apply the attaching seal 75 to the non-sealed part.

Next, the valve sheet 51 will be described. The valve sheet 51 is sealed at its upper portion (preferably, uppermost end) to the filter sheet 41 and the basic sheet 31 by the valve sheet fixing portion 71. However, a sealing position between the valve sheet 51 and the filter sheet 41 and a sealing position between the filter sheet 41 and the basic sheet 31 may be set at different positions.

The valve sheet 51 is, in a region lower than the valve sheet fixing portion 71, not adhered to the filter sheet 41, and can move in the thickness direction of the valve sheet 51. As in the conventional check valve, the valve sheet 51 including its lower region is fixed at both lateral sides by the side seals 74 described above, but a large part of the center can move in the thickness direction, and the valve sheet 51 contacts and separates with respect to the fluid path forming sheet 21 to thereby perform opening or closing of the valve.

Next, the auxiliary sheet 61 will be described. The auxiliary sheet 61 is provided, in relation to the valve sheet 51, to balance the lamination structure and sealing, and does not function as a valve, but as disclosed in Patent Documents 3 and 4, implementation as one that functions as a valve is also possible by protruding the same upward.

The auxiliary sheet 61 is sealed to the basic sheet 31 and the filter sheet 41. In this example, the auxiliary sheet 61 is fixed by the lower seal 73 that extends along a lower face of the check valve 1. However, a sealing position between the auxiliary sheet 61 and the filter sheet 41 and a sealing position between the filter sheet 41 and the basic sheet 31 may be set at different positions.

Similar to the side seal 74 described above, this lower seal 73 can also serve in common as the attaching seal 75. In detail, by applying the attaching seal 75 at the time of fixing to the bag sheet 3 without the lower seal 73 being applied before fixing to the bag body 2, the applied seal can serve as the attaching seal 75 as well as the lower seal 73. Also, even when the lower seal 73 and the attaching seal 75 are provided separately, providing the lower seal 73 as one narrower than the attaching seal 75 and laying the attaching seal 75 on a position covering the lower seal 73 to provide sealing is also possible. Also, two narrow seals may be applied as the lower seal 73, and the attaching seal 75 may be applied to a non-seal part, which is a part with no seal provided between the two narrow side seals.

Lastly, the fluid path forming sheet 21 will be described. An upper portion of the fluid path forming sheet 21 is, by an upper seal portion 72, sealed to an upper portion of the filter sheet 41. Similar to the lower seal portion 73, this upper seal 72 is also formed along an upper side of the check valve 1 so as to connect both right and left sides (between the right and left side seals 74) of the bag. Also, the upper seal 72 can be arranged in the same manner as with the lower seal 73 and the side seal 74 also in relation to the attaching seal 75 described above.

The attaching seal 75 shall now be summarized. The attaching seal 75 is for thoroughly sealing the entire periphery of the check valve 1 to the bag sheet 3 at upper, lower, right, and left sides, and can be formed independently of, in common use with, or in a duplicated manner with the upper seal 72, the lower seal 73, and the right and left side seals 74. Into the check valve 1 attached to an inner surface of the bag sheet 3 by the attaching seal 75, a fluid inside the bag body 2 flows in from the inlet 11 at a back surface side of an upper portion. This fluid passes through the valve flow path 13 in the check valve 1, and flows out from the opening portion 4 to the outside of the bag body 2 via the outlet 12 at a front side of a lower portion.

(Flow of Fluid)

In this check valve 1, the gap between the flow path forming sheet 21 and the valve sheet 51 facing the same serves as the valve flow path 13. With the valve flow path 13, the flow path forming sheet 21 and the valve sheet 51 constantly overlap, but when a fluid flows in from the inlet 11 due to an increase in pressure inside the bag body 2 or the like, the fluid moves the valve sheet 51 to a back surface side, and the valve flow path 13 thus opens to let the fluid flow out. Even if the fluid tends to flow in a reverse direction, because the upper portion of the valve sheet 51 is fixed by the valve sheet fixing portion 71, the gap between the valve sheet 51 and the flow passage forming sheet 21 has a negative pressure relative to that between the inlet 11 and the basic sheet 31. As a result, the valve sheet 51 closely contacts the flow path forming sheet 21, and the valve flow path 13 is closed. A length of the flow path forming sheet 21 is accordingly set on condition that the above valve function is met, and its lower end is set lower than the valve sheet fixing portion 71 and at a position where close contact with the valve sheet 51 can be secured. In the illustrated example, the lower end of the flow path forming sheet 21 is set lower than a lower end of the valve sheet 51, but it may be at the same position, or may be higher than the valve sheet 51. Moreover, the lower end of the fluid path forming sheet 21 is open, and the open part serves as the outlet 12, but in this example, as described above, because the outer periphery of the check valve 1 is adhered to the bag sheet 3 by the attaching seal 75, the gap between the lower end of the fluid path forming sheet 21 and a lower side of the attaching seal 75 (the attaching seal 75 present at the position of the auxiliary sheet 61) serves as the outlet 12. It is also possible to extend the flow path forming sheet 21 to the lower end of the check valve 1 so as to cover the entire surface of the check valve 21. In this case, it suffices to form the outlet 12 by providing a slit or an opening hole in the flow path forming sheet 21.

The fluid having flowed out from the outlet 12 flows out of the bag body 2 from the opening portion 4. In FIG. 2, the opening portion 4 is provided at a position substantially the same as that of the outlet 12 at a lower side, but the opening portion 4 may be provided at any position as long as it is inside of the attaching seal 75. According to circumstances, the bag sheet 3 can be made to serve in common as the flow path forming sheet 21 without providing the flow path forming sheet 21. Because the opening portion 4 serves as the outlet 12 in this case, the opening portion 4 is provided lower than the valve sheet fixing portion 71 and at a position where close contact between the valve sheet 51 and the bag sheet 3 can be secured.

(Description of Deformed Portion 81)

Because the check valve 1 structured as above is used with its entire periphery sealed to the bag sheet 3, when the bag body 2 is increased in internal pressure, as shown by arrows in FIG. 2C, the pressure is applied to the whole of all sheets that form the check valve 1 in their thickness direction. Therefore, the flow path forming sheet 21 and the valve sheet 51 are brought into close contact and a valve opening operation, of a fluid having flowed in from the inlet 11 moving the valve sheet 51 to open the valve, is not smoothly operated in some cases, which lowers the flow-out performance of fluid with a forward flow. When the internal pressure is further increased extremely high, the sheets that form the check valve 1 may be deformed in a warping manner to protrude in an outer side direction of the bag body 2 (forward). Although the designer has made a design assuming, as a normal use state, that the sheets that form the check valve 1 overlap in a substantially planar shape, the warping as described above significantly causes the occurrence of negative effects including a decline in the flow-out performance of fluid with a forward flow.

The present invention therefore has prevented the harmful effects by deforming the check valve 1 and the bag sheet 3 overlapped in front thereof so as to protrude in an inner side direction of the bag body 2 (rearward). In detail, the bag sheet 3 and the sheets (filter sheet 41 and flow path forming sheet 21) that form the check valve 1 in a region including a portion of the flow path forming sheet 21 that is further upstream than the valve sheet fixing portion 71 are respectively deformed to protrude themselves rearward in whole. In the following, the deformed part will be referred to as a deformed portion 81.

The deformed portion 81 is deformed by the respective sheets being curved or bent, and the sheets themselves protrude rearward relative to a part without deformation. Accordingly, a front surface of the deformed portion 81 is recessed rearward relative to a front surface of the part without deformation and a rear surface of the deformed portion 81 protrudes rearward relative to a rear surface of the part without deformation.

In the check valve of Patent Document 4, because the fluid introduction recess portion is formed by a press mold, it is difficult to make the recess greater in degree than the sheet thickness. In contrast, with the deformed portion 81, because the sheets themselves are made to protrude rearward in whole in the region including a portion that is further upstream than the valve sheet fixing portion 71, a degree of protrusion (i.e., a degree to which front surfaces of the sheets in the deformed portion 81 are recessed) can be set relatively freely.

The degree to which the sheets themselves protrude may be small as long as a fluid during forward flow can be introduced into the valve flow path 13 from the valve sheet fixing portion 71, but it is appropriate to make at least a part of the modified portion 81 such as a central part thereof be recessed rearward than a front surface of the attaching seal 75. Specifically, being recessed at a recess depth on the order of 0.5 mm to 3.0 mm from the front surface of the attaching seal 75 is sufficient, and this is preferably on the order of 10 mm or less, and more preferably, 5 mm or less.

Being excessively small in recess depth may prevent the effect of deformation from being exerted, and being excessively great in recess depth may adversely affect the function of the check valve, but the recess depth may exceed the above-described numerical range if no such problems occur.

This alleviates, even when the internal pressure becomes extremely high, the sheets that form the check valve 1 from warping so as to protrude in an outer side direction of the bag body 2 (forward), and even if deformation occurs, allows maintaining a state in which fluid flows readily to a downstream side of the valve sheet fixing portion 71.

More specifically, when a fluid pressure is applied from an inner side direction of the bag body 2 (rear), the check valve 1 tends to closely contact the bag sheet 3. However, due to the provision of the deforming portion 81, the sheets are irregularly deformed, from the state in FIG. 2C into the state shown in FIG. 2D, in an outer side direction of the bag body 2 (in the figure, upward). A gap is thereby formed between the sheets (particularly, between a peripheral part of the valve sheet fixing portion 71 of the valve sheet 51 and the fluid path forming sheet 21). As a result, a fluid inside the bag body 2 is introduced through the gap into the valve flow path 13, a gap is opened between the valve sheet 51 and a downstream-side region of the flow path forming sheet 21, and the fluid flows out smoothly from the outlet 12. Achieving a slight gap once is sufficient for this gap. This is because, when a fluid is once introduced between the valve sheet 51 and the downstream-side region of the flow path forming sheet 21, even if the fluid is slight in amount, the interval between the valve sheet 51 and the downstream-side region of the flow path forming sheet 21 is then gradually opened wide by the fluid that follows.

For the deformed portion 81, it is appropriate to protrude the sheets rearward centered on the inlet 11. This is because it is appropriate to solve an issue of improvement in the introduction of fluid during forward flow on a periphery of the inlet 11 that is further upstream than the valve sheet fixing portion 71 and the possibility of a decline in the reverse flow prevention function of preventing a reverse flow occurs when great deformation is excessively applied to the flow path forming sheet 21 and the valve sheet 51 that form the valve flow path 13 that is downstream of the upstream side inlet 11. Of course, because it has been demanded to downsize the check valve 1 and it is often the case that the inlet 11 also merely occupies a small area in size, it is allowed that the deformed portion 81 possibly extends to a region further downstream than the valve sheet fixing portion 71. The deformation of the deformed portion 81 may thus extend to the whole of the check valve 1 including a region further downstream than the valve sheet fixing portion 71 in some cases. Indeed, applying to the valve flow path 13 such local deformation so as to impair the demanded reverse flow prevention function, etc., is not appropriate, but the valve flow path 13 may be applied with deformation unless such deformation impairs the check valve function.

(Production Example of Deformed Portion 81)

The deformed portion 81 can adopt two methods of a method for forming the same when attaching the check valve 1 to the bag sheet 3 and a method for forming the same separately from the bag sheet 3 in a production process of the check valve 1.

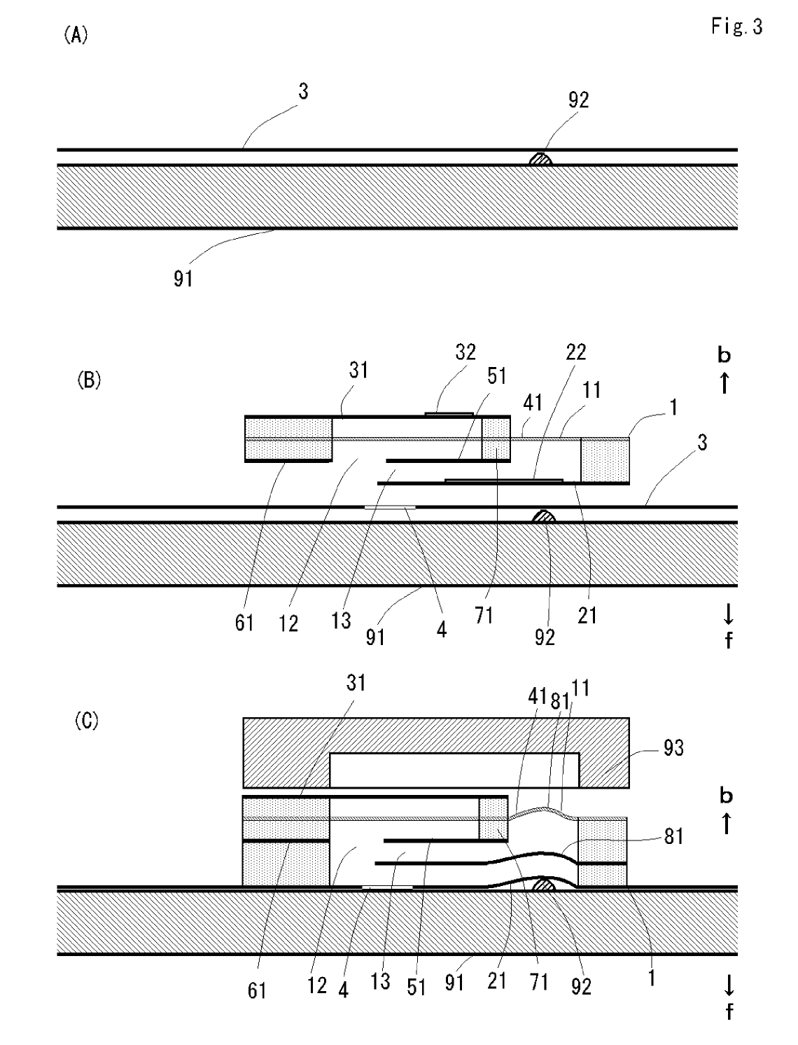

The example in FIG. 3 shows a method for forming the deformed portion 81 in the case of a fixing step of attaching the check valve 1 to the bag sheet 3, and in which respective steps from a first step to a third step are carried out in order.

(First Step)

In this fixing step, first, as shown in FIG. 3A, a bag sheet 3 is disposed on a substrate 91 according to a routine procedure of a production method for a bag body 2. The bag sheet 3 may also be disposed on the substrate 91 in an individually separated state for a single bag body 2, but in the case of performing continuous production, a bag sheet 3 for producing a plurality of bag bodies 2 is supplied in a web-like continuing manner. The bag sheet 3 is in a roll-like state of being rolled according to a routine procedure, and this is unrolled in order and subjected to necessary folding or attachment. In the figure, only a single bag sheet 3 is drawn, but when two sheets are adhered together to produce a bag body 2, two webs are supplied, and are overlaid after adhesion of the check valve 1, whereby a bag body 2 is completed. Of course, it is also possible to complete a bag body 2 by folding and attaching together a single bag sheet 3, and only a single web is supplied in this case. Besides the above, the number of bag sheets 3 used and location of attachment, etc., can be variously changed according to a shape of the bag body 2, but a bag sheet(s) 3 to serve as a target of attachment with the check valve 1 are supplied onto the substrate 91, and is intermittently fed in a longitudinal direction of the web(s) by an automatic feeder (not shown).

The substrate 91 is made, according to a routine procedure of a bag body production apparatus, of a hard and undeformable material such as a metal, a synthetic resin plate, or a wood plate, and its surface is made of a smooth tabular body so that a web feed is smoothly performed.

On the substrate 91, a protrusion portion 92 to form a deformed portion 81 is formed. The protrusion portion 92 can be made of the same hard and undeformable material as the substrate 91, but can also be made of an elastic material, such as rubber, that is relatively soft and deformed under a large force.

It is preferable that the protrusion portion 92 has a size smaller than that of the opening portion 4 in a plan view. Also, a protrusion height from the substrate 91 on the same level as the recess depth of the deformed portion 81 described above is sufficient. However, because the deformed portion 81 does not plastically deform the sheets themselves completely, a protrusion height of the modified portion 81 can also be made slightly greater than a height and than a recess depth of the protrusion portion 92 after processing.

The protrusion portion 92 can also be either completely fixed onto the substrate 91 or removably disposed. Also, its protrusion height can also be made adjustable by, for example, opening a hole in the substrate 91 and disposing the protrusion portion 92 so as to be projectable and retractable from this hole. The protrusion portion 92 can also be provided across a length that is the same or more than a right-left width of the check valve 1, and in this case, the deformed portion 81 is also formed in a state of stretching across both right and left sides of the check valve 1.

(Second Step)

Next, as shown in FIG. 3B, prior to the arrival at the protrusion portion 92, an opening portion 4 is formed by an edged tool or a mold, in the bag sheet 3, at an appointed position to fix the check valve 1. The processing for the opening portion 4 can be performed at either stage of before or after being rolled into a roll form, and the processing for the opening portion 4 may be performed on the same substrate 91 and short of the protrusion portion 92. At the appointed position to fix the check valve 1 where the opening portion 4 and the protrusion portion 92 are in a predetermined positional relationship, the feed of the web of the bag sheet 3 is suspended. During or before the suspension, the check valve 1 is supplied to a position over the bag sheet 3. It is advantageous for continuous production that this check valve 1 is also in a web-like form containing a plurality of continuous check valves, and the check valves are cut apart into individual check valves 1 by an edged tool or the like before being supplied or while being supplied, or as the case may be, after being supplied.

Moreover, as shown in FIG. 3B, it is also preferable to apply in advance by printing or the like a detecting mark 32 for being detected by a phototube to the basic sheet 31 of the check valve 1 so that the check valve 1 is disposed at a predetermined position of the bag sheet 3, particularly, so that a positional relationship between the opening portion 4 in the bag sheet 3 and the check valve 1 is accurately determined. Still moreover, at the rear surface side of the flow path forming sheet 21 (in FIG. 3B, upper side), a modifier layer 22 that adjusts close contact can also be formed in advance. This modifier layer 22 can be formed by coating ink or a silicone resin in advance. As described above, when self-close-contacting films are disposed at the rear surface side of the flow path forming sheet 21 and the front surface side of the valve sheet 51, while the reverse flow prevention function of preventing a reverse flow is enhanced, the valve flow path 13 poorly opens during a forward flow. Therefore, by forming the modifier layer 22 on an upstream portion of the flow path forming sheet 21 to facilitate opening of the valve flow path 13 during forward flow and, on the other hand, by not forming the modifier layer 22 on a downstream portion of the flow path forming sheet 21, the reverse flow prevention function in the gap with the valve sheet 51 can be effectively exerted. It even suffices to only form the modifier layer 22 further upstream than the valve sheet fixing portion 71, and the modifier layer 22 may be formed also at a downstream side of the valve sheet fixing portion 71 on condition that the reverse flow prevention function in the gap with the valve sheet 51 can be effectively exerted.

Although, among the figures, only FIG. 3(B) illustrates the detecting mark 32 and the modifier layer 22, the detecting mark 32 and the modifier layer 22 can be likewise formed in other figures as well.

(Third Step)

Lastly, as shown in FIG. 3C, a mold 93 with its distal end surface heated falls from above the check valve 1, and applies an attaching seal 75. As this attaching seal 75, a commonly used one for heat sealing that is used when carrying out a conventional check valve fixing method is sufficient, and a routine procedure is practiced to press the check valve 1 against the substrate 91 and fuse the bag sheet 3 and the respective sheets that form the check valve 1 by the heated distal end surface of the mold. At this time, because the protrusion portion 92 is aligned with an appointed position to form the deformed portion 81 in the check valve (specifically, a position centered on the opening portion 4), the attaching seal 75 is formed with the respective sheets deformed in a manner of being pushed up by the protrusion portion 92. This deformation is not due to thermal processing directly applied to the location of the deformed portion 81, but heat sealing is merely provided at the position of the attaching seal 75 therearound, and the respective sheets (particularly, the flow path forming sheet 21 and the bag sheet 3) in the deformed portion 81 therefore maintain their flexibility, and the filter sheet 41 is also not clogged. Depending on the height and size of the protrusion portion 92, a side further downstream than a portion except the opening portion 4 (specifically, the valve sheet fixing portion 71) may also have a gentle inclination, but this will not matter if the check valve function is not impaired.

(Positional Relationship with Opening Portion 4)

The positional relationship of the outlet 12 of the check valve 1 with the opening portion 4 of the bag sheet 3 is not particularly limited as long as a fluid from the outlet 12 can flow out to the outside from the opening portion 4, but in the present embodiment, the opening portion 4 is provided further downstream than the valve sheet fixing portion 71. Particularly, in this example, the opening portion 4 shows a substantially T-shape provided with a longitudinal slit 6 extending in a length direction of the check valve from the center of a lateral slit 5 extending in a width direction of the check valve, but the lateral slit 5 is provided at a position further downstream than a downstream end of the fluid path forming sheet 21 and a downstream end of the valve sheet 51, and the longitudinal slit 6 extends from the lateral slit 5 to an upstream side and reaches a side further upstream than the downstream end of the fluid path forming sheet 21 and the downstream end of the valve sheet 51. This opening portion 4 is formed in a T-shape in order to make the interval between the fluid path forming sheet 21 and the valve sheet 51 increase readily when a fluid passes through the valve flow path 13 at the time of a forward flow. Specifically, when the interval is increased, portions of the bag sheet 3 on both sides of the longitudinal slit 6 are expanded in right and left divisions, and this makes fluid pass through the valve flow path 13 readily and the fluid from the expanded opening portion 4 be evacuated to the outside readily. Of course, the opening portion 4 is not limited to this shape, and the shape of a slit (s) to serve as the opening portion 4 can be changed as suited, and a cutout hole covering some area can also be adopted as the opening portion 4. Still moreover, the opening portion 4 may also be formed as a large number of dot-like pores, and can be implemented in various shapes through which fluid passes.

### Another Embodiment

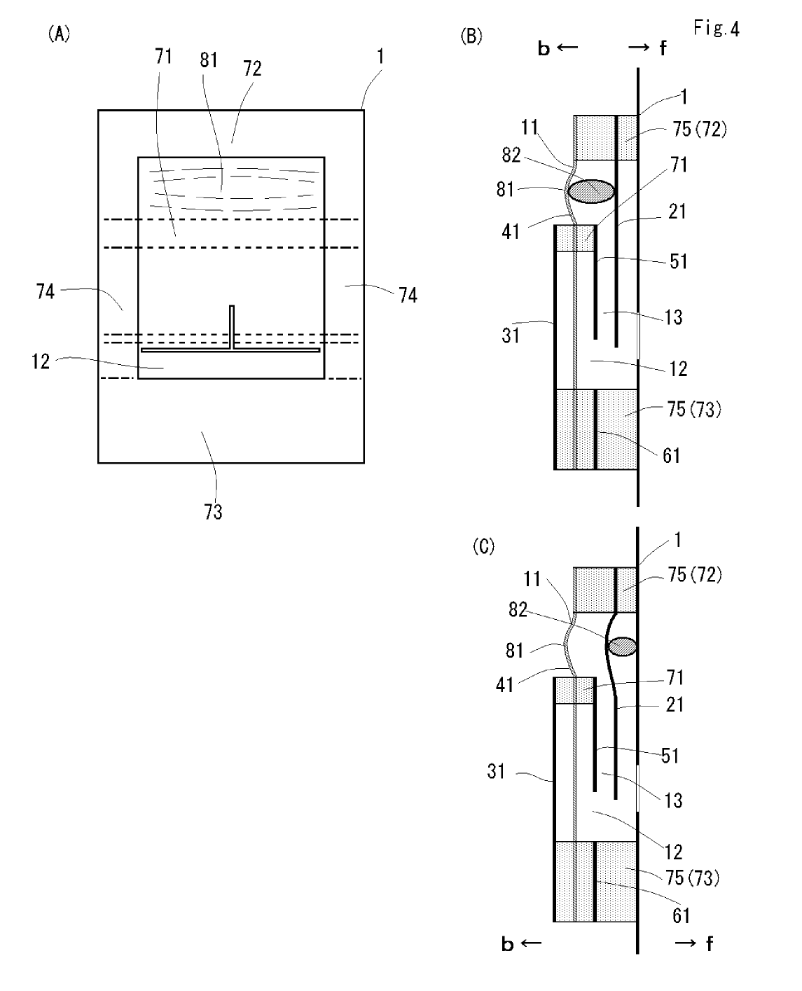

A second embodiment of the present invention shall now be described with reference to FIG. 4. With the previous embodiment, the deformed portion 81 is formed by forming the protrusion portion 92 on the substrate 91, whereas in the present embodiment, the deformed portion 81 is formed by providing a deformation maintaining member 82 for the check valve 1. Because the second embodiment is substantially the same as the previous embodiment in the arrangement of the check valve 1 and the bag sheet 3, only a different portion(s) will be described, and other portions will be denoted by the same reference numerals to omit description thereof.

In the present embodiment, as shown in FIG. 4B, inside of a region provided with the inlet 11, the deformation maintaining member 82 is provided between a front surface of the filter sheet 41 and a rear surface of the basic sheet 31. The deformation maintaining member 82 can be formed of a member that is high in a thickness direction, and can use, for example, a thread or wire made of synthetic resin, synthetic fiber, natural fiber, wood, metal, or a composite material of these can be used. The deformation maintaining member 82 is laid across the right and left side seals 74, and fixed at its both ends by side seals. By using a heat-sealable synthetic resin or synthetic fiber, the deformation maintaining member 82 can be fixed by application of the side seals 74 and the attaching seal 75, but even a non-heat-sealable material is brought into a state of being sandwiched by sealed portions by application of the side seals 74 and the attaching seal 75, and thus can be disposed in an immovable state. In FIG. 4(B), because the respective overlapping sheets are drawn in a state of being spaced by intervals, the deformation maintaining member 82 is drawn with an oval-shaped section, but in actuality, the section is substantially circular. However, implementation with a section being in another shape such as an oval shape or a polygonal shape is possible.

When the check valve 1 is mass-produced, the respective sheets are usually produced as sheets that are continuous in a right-left direction of FIG. 4A, and at this time, the deformation maintaining member 82 is also produced as a member that is continuous in the right-left direction, and cut into each check valve one by one after being applied with a predetermined seal(s).

The check valve 1 is produced through the same steps as the steps described with the previous embodiment, and as figures showing the production steps, FIG. 3 is quoted. Specifically, the attaching seal 75 is applied by the mold 93 being closed with the bag sheet 3 disposed on the substrate 91 and the check valve 1 disposed thereon. At this time, due to the presence of the deformation maintaining member 82, the filter sheet 41 is brought into a recessed state at the position of the inlet 11. As a result, even when the pressure inside the bag body 2 is increased, the state in which the gap between the valve sheet 51 fixed at its upper end by the valve sheet fixing portion 71 to the filter sheet 41 and the fluid path forming sheet 21 is expanded readily can be maintained, and as in the previous embodiment, the flow of fluid during forward flow can be improved.

Next, FIG. 4C shows an example in which the deformation maintaining member 82 is disposed at a front surface side of the flow path forming sheet 21. Also in this case, the attaching seal 75 is applied by the mold 93 being closed with the bag sheet 3 disposed on the substrate 91 and the check valve 1 disposed thereon. At this time, due to the presence of the deformation maintaining member 82, the filter sheet 41 and the fluid path forming sheet 21 are brought into a rearwardly protruding state at the position of the inlet 11. As a result, as in the first embodiment, a gap is formed between the sheets (particularly, between a peripheral part of the valve sheet fixing portion 71 of the valve sheet 51 and the fluid path forming sheet 21). As a result, a fluid inside the bag body 2 is introduced through the gap into the valve flow path 13, a gap is opened between the valve sheet 51 and a downstream-side region of the flow path forming sheet 21, and the fluid flows out smoothly from the outlet 12.

Although the illustration is omitted, providing the deformation maintaining member 82 at a front surface side of the bag sheet 3 can exert the same effects.

In the respective examples shown in FIG. 4, the deformation maintaining member 82 is thus provided as a member that is continuous in a right-left direction of the check valve 1, but can be changed as suited in its shape, and can even be changed to a hemispherical shape, a polyhedral shape, or the like. Also, the deformation maintaining member 82 can also be provided in plural numbers. At this time, all of the plurality of deformation maintaining members 82 can also be disposed between the front surface of the filter sheet 41 and the rear surface of the basic sheet 31, and all of them can also be disposed at the front surface side of the fluid path forming sheet 21. Also, the deformation maintaining members 82 can also be disposed at both positions of a front surface side and a rear surface side of the basic sheet 31.

### Still Another Embodiment

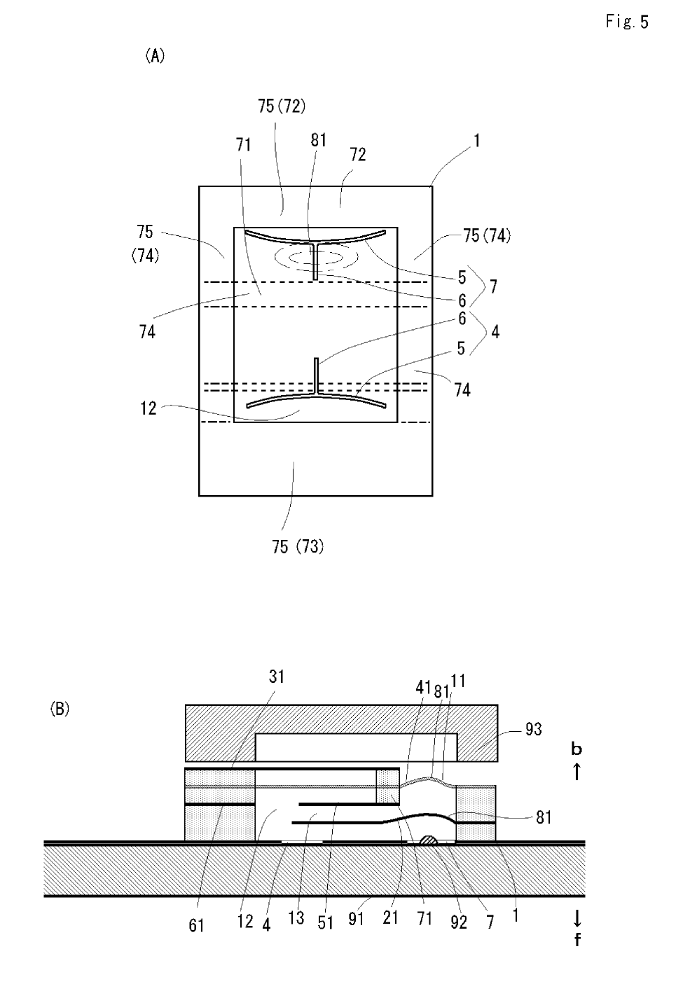

A third embodiment of the present invention shall now be described with reference to FIG. 5. With the two previous embodiments, the opening portion 4 is provided in front of the outlet 12, whereas in the present embodiment, an opening portion (hereinafter, referred to as an upper opening portion 7) is also provided in front of the deformed portion 81. Because the third embodiment corresponds to the first embodiment that is modified in the arrangement of the bag sheet 3, only a different portion(s) will be described, and other portions will be denoted by the same reference numerals to omit description thereof.

In the bag sheet 3 according to the present embodiment, the upper opening portion 7 is formed at a position in front of the modified portion 81. As shown in FIG. 5A, this upper opening portion 7 is provided in addition to the opening portion 4 (hereinafter, in the description of the present third embodiment, which will be referred to as the lower opening portion 4 for distinction from the upper opening portion 7) mentioned in the previous embodiment, but implementation is even possible only with the upper opening portion 7 without providing the lower opening portion 4. The upper opening portion 7 shows a shape vertically symmetrical with the lower opening portion 4. Specifically, the upper opening portion 7 shows a substantially T-shape provided with a longitudinal slit 6 extending downward in a length direction of the check valve extending from the center of a lateral slit 5 extending in a width direction of the check valve. This allows the protrusion portion 92, as shown in FIG. 5B, when the deformed portion 81 is formed by the protrusion portion 92, to make entry in a manner of opening the upper opening portion 7 so as to directly push the fluid path forming sheet 21. Of course, there may be a case where the protrusion portion 92 does not completely enter the inside through the upper opening portion 7, but even in that case, because the bag sheet 3 opens readily, a force that the protrusion portion 92 pushes the fluid path forming sheet 21, etc., is transmitted readily, and the deformed portion 81 can be formed reliably. Particularly, when a material that is greater in thickness and less deformable than the respective sheets that form the check valve 1 is used for the bag sheet 3, implementation of the same with the lower opening portion 7 provided is preferable.

### Modification

The present invention should not be understood to be limited to the respective embodiments described above.

For example, the deformed portions 81 according to both embodiments of the formation of the deformed portion 81 by the protrusion portion 92 according to the first embodiment and the deformed portion 81 by the deformation maintaining member according to the second embodiment may be used in combination.

Moreover, like the check valves in the modes disclosed in Patent Document 3 and the Patent Document 4, application is also possible to one for which a plurality of valve sheets are disposed in a fluid flow direction. Still moreover, application is also possible to one for which a plurality of valve sheets are disposed in a thickness direction. Also, like the check valve in the mode disclosed in Patent Document 4, an introduction recess portion by a press mold may be formed in a valve sheet fixing portion on at least either one of the fluid path forming sheet 21 and the valve sheet 51.

Further, the check valve 1 can also be fixed by being sandwiched between two bag sheets 3 that form a bag body. In this case, the check valve 1 is fixed, in the position of the valve sheet fixing portion 71, by heat sealing or the like in a state of being sandwiched by the two bag sheets 3.

Although the check valve 1 is disposed at an inner side of the bag body 2 in the previous embodiment, the check valve 1 can also be disposed at an outer side of the bag body 2. Also, the forward flow is set in a direction to pass through the bag body 2 from the inner side to the outer side, but the forward flow can also be set in a direction to enter the inner side of the bag body 2 from the outer side.

### DESCRIPTION OF THE REFERENCE NUMERALS

1 Check valve
2 Bag body
3 Bag sheet
4 Opening portion (upper opening portion)
5 Lateral slit
6 Longitudinal slit
7 Lower opening portion
11 Inlet
12 Outlet
13 Valve flow path
21 Flow path forming sheet
22 Modifier layer
31 Base sheet
32 Detecting mark
41 Filter sheet
51 Valve sheet
61 Auxiliary sheet
71 Valve sheet fixing portion
72 Upper seal
73 Lower seal
74 Side seal
75 Attaching seal
81 Deformed portion
82 Deformation maintaining member
91 Substrate
92 Protrusion portion
93 Mold

1. A check valve structure of a bag body including a bag sheet that forms a bag body, and a check valve made of a sheet and fixed to the bag sheet,
the check valve made of a sheet being comprised of a valve sheet, a fluid path forming sheet disposed in front of the valve sheet, and a basic sheet disposed behind the valve sheet,
the valve sheet being fixed by a valve sheet fixing portion at an upper end side, being movable in a thickness direction at a lower end side,
having an inlet provided at an upper side than the valve sheet fixing portion, and having an outlet provided at a lower side than the valve sheet fixing portion,
the flow path forming sheet including an upstream portion that is at an upper side than the valve sheet fixing portion, and a downstream portion that is at a lower side than the valve sheet fixing portion,
the valve sheet, by its movement in the thickness direction, contacting and separating from the downstream portion of the flow path forming sheet to open or close the valve, and
the check valve controlling flow of a fluid inside and outside of the bag body,
wherein a deformed portion is formed, in a region including the upstream portion that is at an upper side than the valve sheet fixing portion, on at least one sheet of the sheets that form the check valve,
the sheet itself of the deformed portion protrudes rearward relative to a part without deformation, and
a front surface of the deformed portion is recessed rearward relative to a front surface of a part without deformation, and a rear surface of the deformed portion protrudes rearward relative to a rear surface of a part without deformation.

2. The check valve structure of a bag body according to claim 1, wherein
a filter sheet is disposed at a position to cover at least the inlet from behind,
the check valve is fixed to the bag sheet by an attaching seal,
in a region including the inlet, all sheets that form the check valve and the bag sheet include the deformed portion, and
the deformed portion is, in at least a portion thereof, recessed rearward relative to a front surface of the attaching seal.

3. The check valve structure of a bag body according to claim 1, wherein
a filter sheet is disposed at a position to cover at least the inlet from behind, and
in a region including the inlet, at least the filter sheet of the sheets that form the check valve includes the deformed portion, and includes a deformation maintaining member disposed further to the front than the deformed portion of the filter sheet.

4. The check valve structure of a bag body according to claim 1, wherein
the bag sheet includes an opening portion, the check valve is fixed by an attaching seal at a position to cover the opening portion from behind,
the bag sheet and the check valve are sealed by the attaching seal in an entire periphery of the check valve,
the inlet is open toward the rear in a region at an upper side than the valve sheet fixing portion of the check valve,
the inlet is open toward the front in a region at a lower side than the valve sheet fixing portion of the check valve, and
when a pressure inside the bag has become higher than a pressure outside the bag, a fluid inside the bag flows in the inside of the check valve from the inlet, passes between the flow path forming sheet and the valve sheet, and flows out to the outside of the bag from the opening portion via the outlet.

5. The check valve structure of a bag body according to claim 4, wherein the opening portion includes an upper opening portion positioned in front of the deformed portion.

6. A method for producing a bag body provided with a check valve structure,
when fixing a check valve made of a sheet to a bag sheet that forms a bag body,
preparing the bag sheet having an opening portion formed therein and the check valve, and
comprising a fixing step of disposing the check valve behind the opening portion, and fixing an entire periphery of the check valve to the bag body by an attaching seal,
wherein the check valve is comprised of:
a valve sheet being fixed by a valve sheet fixing portion at an upper end side, being movable in a thickness direction at a lower end side;
an inlet and an outlet provided across the valve sheet fixing portion at an inner side and a lower side, respectively;
a flow path forming sheet disposed in front of the valve sheet; and
a basic sheet disposed behind the valve sheet,
the flow path forming sheet includes an upstream portion that is at an upper side than the valve sheet fixing portion, and a downstream portion that is at a lower side than the valve sheet fixing portion,
the valve sheet, by its movement in the thickness direction, contacts and separates from the downstream portion of the flow path forming sheet to open or close the valve,
the check valve controls flow of a fluid inside and outside of the bag body that is performed through the opening portion, and
the fixing step comprising:
providing a protrusion portion on a substrate;
disposing the check valve on the substrate in alignment so that at least a portion that is at an upper side than the valve sheet fixing portion is positioned in front of the protrusion portion and an outer periphery of the check valve is positioned in front of the substrate without the protrusion portion;
disposing the bag sheet on the check valve; and
sealing an outer periphery of the check valve and the bag seat from above the bag sheet, and thereby forming a deformed portion that protrudes rearward relative to the attaching seal, on the check valve and the bag sheet overlapped in front thereof, in at least a region including the upstream portion of the flow path forming sheet.

7. The check valve structure of a bag body according to claim 2, wherein
a filter sheet is disposed at a position to cover at least the inlet from behind, and
in a region including the inlet, at least the filter sheet of the sheets that form the check valve includes the deformed portion, and includes a deformation maintaining member disposed further to the front than the deformed portion of the filter sheet.

8. The check valve structure of a bag body according to claim 2, wherein
the bag sheet includes an opening portion, the check valve is fixed by an attaching seal at a position to cover the opening portion from behind,
the bag sheet and the check valve are sealed by the attaching seal in an entire periphery of the check valve,
the inlet is open toward the rear in a region at an upper side than the valve sheet fixing portion of the check valve,
the inlet is open toward the front in a region at a lower side than the valve sheet fixing portion of the check valve, and
when a pressure inside the bag has become higher than a pressure outside the bag, a fluid inside the bag flows in the inside of the check valve from the inlet, passes between the flow path forming sheet and the valve sheet, and flows out to the outside of the bag from the opening portion via the outlet.

9. The check valve structure of a bag body according to claim 3, wherein
the bag sheet includes an opening portion, the check valve is fixed by an attaching seal at a position to cover the opening portion from behind,
the bag sheet and the check valve are sealed by the attaching seal in an entire periphery of the check valve,
the inlet is open toward the rear in a region at an upper side than the valve sheet fixing portion of the check valve,
the inlet is open toward the front in a region at a lower side than the valve sheet fixing portion of the check valve, and
when a pressure inside the bag has become higher than a pressure outside the bag, a fluid inside the bag flows in the inside of the check valve from the inlet, passes between the flow path forming sheet and the valve sheet, and flows out to the outside of the bag from the opening portion via the outlet.
